(19) United States
(12) Patent Application Publication
(10) Pub. No.: US 2025/0132313 A1
(43) Pub. Date: Apr. 24, 2025

(54) NEGATIVE ELECTRODE ACTIVE MATERIAL, METHOD OF PREPARING SAME, AND RECHARGEABLE LITHIUM BATTERY INCLUDING SAME

(71) Applicant: SAMSUNG SDI CO., LTD., Yongin-si (KR)

(72) Inventors: Eunji KANG, Yongin-si (KR); Youngugk KIM, Yongin-si (KR); Deok-Hyun KIM, Yongin-si (KR); Sunil PARK, Yongin-si (KR); Ilyoung CHOI, Yongin-si (KR); Jaewon KIM, Yongin-si (KR); Hyejin KIM, Yongin-si (KR); Doori OH, Yongin-si (KR); Narae KIM, Yongin-si (KR); Yookyung KIM, Yongin-si (KR); Banseok LEE, Yongin-si (KR)

(21) Appl. No.: 18/636,336

(22) Filed: Apr. 16, 2024

(30) Foreign Application Priority Data
Oct. 19, 2023 (KR) 10-2023-0140697

(51) Int. Cl. H01M 4/36; H01M 4/133; H01M 4/587; H01M 10/052

(52) U.S. Cl. CPC H01M 4/366; H01M 4/133; H01M 4/587; H01M 10/052

(57) ABSTRACT

A negative electrode active material includes a core including secondary particles in which silicon primary particles and a metal carbide are agglomerated; and an amorphous carbon layer on a surface of the core, wherein the primary particles have a full width at half maximum (FWHM, 111) of greater than about 0.5°.

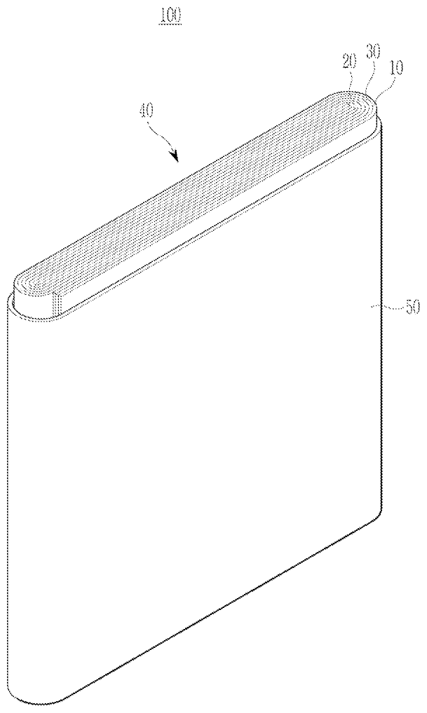

### CROSS-REFERENCE TO RELATED APPLICATION

This application claims priority to and the benefit of Korean Patent Application No. 10-2023-0140697 filed in the Korean Intellectual Property Office on Oct. 19, 2023, the entire contents of which are incorporated herein by reference.

### BACKGROUND

### 1. Field

Embodiments relate to a negative electrode active material, a method of preparing the same, and a rechargeable lithium battery including the same.

### 2. Description of the Related Art

Recently, the rapid supplement of electronic devices such as mobile phones, laptop computers, and electric vehicles using batteries require surprising increases in demand for rechargeable batteries with relatively high capacity and lighter weight.

The development of batteries with a high energy density has been considered, e.g., using high-capacity negative electrode active materials. For example, a Si negative electrode active material may be used as the high-capacity negative electrode active material.

### SUMMARY

The embodiments may be realized by providing a negative electrode active material including a core including secondary particles in which silicon primary particles and a metal carbide are agglomerated; and an amorphous carbon layer on a surface of the core, wherein the primary particles have a full width at half maximum (FWHM, 111) of greater than about 0.5°.

The full width at half maximum of the primary particles may be greater than about 0.5° and about 2° or less.

The metal carbide may be included in an amount of about 5 wt % to about 30 wt %, based on a total weight of the negative electrode active material.

The metal carbide may include a metal having a strength of about 1,000 kg/mm² to about 2,000 kg/mm².

The metal may include Cr, Mo, Ta, or a combination thereof.

The metal carbide may include Cr₃C₂, Mo₂C, TaC, or a combination thereof.

The amorphous carbon layer may further include a metal carbide.

The silicon primary particles may be included in an amount of about 30 wt % to about 70 wt %, based on a total weight of the negative electrode active material.

The embodiments may be realized by providing a method of preparing a negative electrode active material, the method including pulverizing silicon particles and a metal carbide by using a ceramic ball to prepare a pulverized product; adding the pulverized product to a solvent to prepare a dispersed liquid; spay-drying the dispersed liquid to prepare an agglomerated product; mixing the agglomerated product with an amorphous carbon precursor; and heat-treating the resulting mixture.

A weight ratio of the silicon particles and the metal carbide may be about 1:1 to about 10:1.

The metal carbide may include Cr₃C₂, Mo₂C, TaC, or a combination thereof

The ceramic ball may include a zirconia ball, an yttrium-stabilized zirconia ball, an alumina ball, or a combination thereof.

The embodiments may be realized by providing a rechargeable lithium battery including a negative electrode including the negative electrode active material according to an embodiment; a positive electrode; and an electrolyte.

### BRIEF DESCRIPTION OF THE DRAWING

Features will be apparent to those of skill in the art by describing in detail exemplary embodiments with reference to the attached drawing in which:

the FIGURE is a schematic view showing a structure of a rechargeable lithium battery according to embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “combination thereof” may include a mixture, a laminate, a complex, a copolymer, an alloy, a blend, a reactant of constituents.

As used herein, the term “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

The drawings show that the thickness is enlarged in order to clearly show the various layers and regions, and the same reference numerals are given to similar parts throughout the specification. If an element, such as a layer, a film, a region, a plate, and the like is referred to as being “on” or “over” another part, it may include cases where it is “directly on” another element, but also cases where there is another element in between. In contrast, when an element is referred to as being “directly on” another element, there are no intervening elements present.

Herein, “layer” includes a shape totally formed on the entire surface or a shape partial surface, when viewed from a plane view.

Herein, “of” is not to be construed as an exclusive meaning, e.g., “A or B” is construed to include A, B, A+B, and the like.

Unless otherwise defined in the specification, a particle diameter or size may be an average particle diameter. The average particle diameter indicates an average value of the diameter of the particles depending on a cumulative volume in the particle size distribution of particles included in the negative electrode active material. The average particle diameter D50 may be measured by a method well known to those skilled in the art, for example, by a particle size analyzer, or a transmission electron microscope image, or a scanning electron microscope image. In another embodiments, a dynamic light-scattering measurement device is used to perform a data analysis, and the number of particles is counted for each particle size range, and from this, the average particle diameter (D50) value may be easily obtained through a calculation, or a laser diffraction method.

A negative electrode active material according to one or more embodiments may include, e.g., a core (including secondary particles in which silicon primary particles and metal carbide (e.g., metal carbide primary particles) are agglomerated); and an amorphous carbon layer on a surface of the core. A full width at half maximum (FWHM, 111) of the primary particle may be greater than about 0.5°, e.g., may be greater than about 0.5° and about 2° or less, greater than about 0.5° and about 1° or less, or about 0.6° to about 1°.

In an implementation, the negative electrode active material may include primary particles with a full width at half maximum (FWHM, 111) of greater than about 0.5°, and the silicon primary particles with the FWHM may have less volume change upon charge and discharge, resulting in no loss of capacity and efficiency.

In an implementation, an amount of the silicon primary particles may be, based on the total weight of the negative electrode active material, e.g., about 30 wt % to about 70 wt %, about 35 wt % to about 70 wt %, or about 35 wt % to about 60 wt %.

In an implementation, a particle diameter D50 of the secondary particle may be, e.g., about 1 μm to about 50 μm, about 2 μm to about 40 μm, or about 5 μm to about 20 μm in the core. Maintaining the particle diameter of the secondary particle within the ranges may help ensure that a slurry for preparing a negative electrode may be readily prepared and the desired energy density may be better achieved.

The metal in the metal carbide may serve to impart strength. In an implementation, the metal of the metal carbide may have a strength of, e.g., about 1,000 kg/mm² to about 2,000 kg/mm². In an implementation, the metal of the metal carbide may include, e.g., Cr, Mo, Ta, or a combination thereof. In an implementation, the strength may indicate Mohs hardness, and it may be a value measured at, e.g., about 20° C. to about 25° C., or about 20° C. Carbide may serve to provide a dynamic effect. If an oxide were to be used instead of carbide, the dynamic effect may be not imparted.

In an implementation, the metal carbide may include, e.g., Cr₃C₂, Mo₂C, TaC, or a combination thereof.

The inclusion of such a metal carbide in the negative electrode active material may impart the negative electrode active material with a high-strength skeleton, thereby suppressing the occurrence of cracks caused by volume changes during charging and discharging, and preventing the collapse of the negative electrode active material structure. The electrical conductivity may be improved, thereby exhibiting excellent high rate cycle-life characteristics.

In an implementation, an amount of the metal carbide may be, e.g., based on the total weight of the negative electrode active material, about 5 wt % to about 30 wt %, about 7 wt % to about 30 wt %, or about 10 wt % to about 30 wt %. Maintaining the amount of the metal carbide within the ranges may help ensure that the high strength imparting and dynamics performance may be further enhanced, without deteriorating the electrochemical characteristics.

In the negative electrode active material according to one or more embodiments, the amorphous carbon coating layer may impart uniform reactivity and buffering properties to the surface of the negative electrode active material, and may help suppress silicon volume expansion during charging and discharging, thereby enabling stable cycle-life performance and capacity efficiency.

In the amorphous carbon coating layer, amorphous carbon may include, e.g., soft carbon, hard carbon, mesophase pitch carbide, sintered coke, or a combination thereof. A thickness of the amorphous carbon coating layer may be, e.g., more than about 0 nm and about 2 μm or less, about 1 nm to about 2,000 nm, or about 1 nm to about 1,000 nm. The thickness refers to a thickness of the amorphous carbon located on the surface of the core. In an implementation, the amorphous carbon may be unevenly located or distributed, and it may refer to the thickest thickness. In an implementation, the thickness may also be an average thickness. Maintaining the thickness of the amorphous carbon coating layer within the ranges may help ensure that the charge and discharge efficiency, and rate capability may be further enhanced.

In the negative electrode active material, an amount of the amorphous carbon coating layer may be, e.g., based on the total weight of the negative electrode active material, about 10 wt % to about 40 wt %, or about 15 wt % to about 40 wt %.

The negative electrode active material according to one or more embodiments may be prepared by the following procedures.

Micrometer sized silicon particles and metal carbide may be pulverized using a ceramic ball. This pulverization may prepare nano-sized silicon primary particles from the micrometer-sized silicon particles.

In an implementation, the pulverization may be carried out for about 1 hour to about 9 hours. According to this procedure, the silicon primary particles may be prepared and silicon primary particles with a full width at half maximum (FWHM, 111) of greater than about 0.5°, e.g., greater than about 0.50 and about 2° or less, greater than about 0.5° and about 10, or about 0.6° to about 10, may be prepared. The metal carbide may be a carbide that is harder than silicon, and may help pulverize only the nano-sized silicon particles into smaller sizes without pulverizing the ceramic balls used in the pulverizing process.

The ceramic balls may include, e.g., a zirconia ball, an yttrium-stabilized zirconia ball, an alumina ball, or a combination thereof.

A weight ratio of the silicon particle and the metal carbide may be, e.g., about 1:1 to about 10:1, about 1.5:1 to about 7:1, or about 1.5:1 to about 5:1. Maintaining the weight ratio of the silicon particle and the metal carbide within the ranges may help ensure that silicon primary particles with a full width at half maximum (FWHM, 111) of greater than about 0.5°, e.g., greater than about 0.50 and about 2° or less, greater than about 0.5° and about 10, or about 0.6° to about 10, may be well prepared, without deteriorating electrochemical characteristics.

The pulverized product may be added to a solvent to prepare a dispersed liquid.

The solvent may include, e.g., isopropyl alcohol, ethanol, butanol, N-methyl pyrrolidone, propylene glycol, or a combination thereof.

A dispersant may also be added to the dispersed liquid. The dispersant may include, e.g., stearic acid, ethylene glycol, citric acid, polyvinyl pyrrolidone (PVP), boron nitride (BN), MgS, or a combination thereof. A weight ratio of the pulverized product:dispersant may be about 99:1 to about 80:20, about 97:3 to about 85:15, or about 95:5 to 87:13.

The resulting mixture may be dried. The drying may be carried out by, e.g., a spray drying. By performing the drying using the spray drying, it may prepare a dried product with particles having a more uniform particle diameter and spherical shape, and it may also to prepare secondary particles where the silicon primary particles and metal carbide are agglomerated together, may be prepared.

An amorphous carbon layer may be prepared or formed on the dried product. The amorphous carbon layer preparation may be performed by vapor coating with an amorphous carbon precursor gas or mixing the dried product with an amorphous carbon precursor and heat-treating.

The amorphous carbon precursor gas may include, e.g., methane (CH₄) gas, ethylene (C₂H₄) gas, acetylene (C₂H₂) gas, propane (C₃H₈) gas, propylene C₃H₆) gas, or a combination thereof. In an implementation, the amorphous carbon precursor may include, e.g., petroleum coke, coal coke, petroleum pitch, coal pitch, green cokes, or a combination thereof.

A mixing ratio of the dried product and the amorphous carbon precursor may be, e.g., a weight ratio of about 95:5 to 30:70 or a weight ratio of about 90:10 to about 40:60.

The heat-treatment may be performed at about 600° C. to about 1,000° C. In the heat treatment, the dispersant may be removed. The amorphous carbon precursor may form amorphous carbon, thereby preparing an amorphous carbon layer.

Another embodiment provides a rechargeable lithium battery including, e.g., a negative electrode, a positive electrode, and an electrolyte.

The negative electrode may include a current collector and a negative electrode active material layer on the current collector and including the negative electrode active material according to one or more embodiments.

The negative electrode active material according to some embodiments may include as a first negative electrode active material and may include crystalline carbon, e.g., as a second negative electrode active material. A mixing ratio of the first negative electrode active material and the second negative electrode active material may be a weight ratio of about 80:20 to about 90:10. In an implementation, the negative electrode active material may include the first negative electrode active material and the second negative electrode active material at a weight ratio of about 85:15 to about 90:10.

In the negative electrode active material layer, an amount of the negative electrode active material may be about 95 wt % to about 98 wt %, based on the total weight of the negative electrode active material layer.

In an implementation, the negative electrode active material layer may include a binder or a conductive material. The amount of the binder may be about 1 wt % to about 5 wt %, based on the total weight of the negative electrode active material layer. The amount of the conductive material may be about 1 wt % to about 5 wt %, based on the total weight of the negative electrode active material layer.

The binder may help improve binding properties of negative electrode active material particles with one another and with a current collector. The binder may be a non-aqueous binder, an aqueous binder, or a combination thereof.

The non-aqueous binder may include, e.g., an ethylene propylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamide imide, polyimide, or a combination thereof.

The aqueous binder may include, e.g., a styrene-butadiene rubber (SBR), an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polypropylene, polyepichlorohydrin, polyphosphazene, an ethylene propylene diene copolymer, polyvinyl pyridine, chlorosulfonated polyethylene, latex, polyester resin, an acrylic resin, a phenolic resin, an epoxy resin, polyvinyl alcohol, or a combination thereof.

In an implementation, the aqueous binder may be used as the negative electrode binder, and a cellulose compound may be further included to help provide viscosity as a thickener. The cellulose compound may include, e.g., carboxymethyl cellulose, hydroxypropylmethyl cellulose, methyl cellulose, or alkali metal salts thereof. The alkali metal may be Na, K, or Li. Such a thickener may be included in an amount of about 0.1 parts by weight to about 3 parts by weight, based on 100 parts by weight of the negative electrode active material.

The conductive material may impart conductivity to the electrode, and a suitable material that does not cause chemical change and conducts electrons may be used in the battery. Examples thereof may include a carbon material such as natural graphite, artificial graphite, carbon black, acetylene black, ketjen black, a carbon fiber; a metal material including copper, nickel, aluminum, silver, etc. in a form of a metal powder or a metal fiber; a conductive polymer such as a polyphenylene derivative; or a mixture thereof.

The current collector may include a copper foil, a nickel foil, a stainless steel foil, a titanium foil, a nickel foam, a copper foam, a polymer substrate coated with a conductive metal, and a combination thereof.

The positive electrode may include a current collector and a positive electrode active material layer on the current collector.

The positive electrode active material may include lithiated intercalation compounds that reversibly intercalate and deintercalate lithium ions. In an implementation, a composite oxide of lithium and a metal, e.g., cobalt, manganese, nickel, or combinations thereof, may be used. In an implementation, the compounds represented by one of the following chemical formulae may be used. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}Co_{b}X_{c}D¹_{α} (0.90≤a≤1.8, 0≤b≤0.5, 0≤c≤0.5, 0≤α≤2); LiₐNi_{1-b-c}Co_{b}X_{c}O_{2-α}T_{α} (0.90≤a≤1.8, 0≤b≤0.5, 0≤c≤0.5, 0≤a≤2); LiₐNi_{1-b-c}Co_{b}X_{c}O_{2-α}T₂ (0.90≤a≤1.8, 0≤b≤0.5, 0≤c≤0.5, 0≤α≤2); LiₐNi_{1-b-c}Mn_{b}X_{c}D¹_{α} (0.90≤a≤1.8, 0≤b≤0.5, 0≤c≤0.5, 0≤α≤2); LiₐNi_{1-b-c}Mn_{b}X_{c}O_{2-α}T_{α} (0.90≤a≤1.8, 0≤b≤0.5, 0≤c≤0.5, 0≤α≤2); LiₐNi_{1-b-c}Mn_{b}X_{c}O_{2-α}T₂ (0.90≤a≤1.8, 0≤b≤0.5, 0≤c≤0.5, 0≤α≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1) LiₐCoG_{b}O₂(0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃(0≤f≤2); Li_{(3-f)}Fe₂(PO₄)₃ (0≤f≤2); LiₐFePO₄ (0.90≤a≤1.8)

In the above chemical formulas, A may be Ni, Co, Mn, or combinations thereof, X may be Al, Ni, Co, Mn, Cr, Fe, Mg, Sr, V, a rare earth element, and combinations thereof, D¹ may be O, F, S, P, or combinations thereof, E may be Co, Mn, or combinations thereof, T may be F, S, P, or combinations thereof, G may be Al, Cr, Mn, Fe, Mg, La, Ce, Sr, V, or combinations thereof, Q may be Ti, Mo, Mn, or combinations thereof, Z may be Cr, V, Fe, Sc, Y, or combinations thereof, J may be V, Cr, Mn, Co, Ni, Cu, or combinations thereof, and L¹ may be Mn, Al, or combinations thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, e.g., the method may include any coating method such as spray coating, dipping, or the like.

In the positive electrode, an amount of the positive electrode active material may be about 90 wt % to about 98 wt %, based on the total weight of the positive electrode active material layer.

In an implementation, the positive electrode active material layer may further include a binder and a conductive material. The binder and the conductive material may each be included in an amount of about 1 wt % to about 5 wt %, respectively, based on the total weight of the positive electrode active material layer.

The binder may help improve binding properties of positive electrode active material particles with one another and with a current collector. Examples of the binder may include polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, an acrylated styrene butadiene rubber, an epoxy resin, nylon, and the like.

The conductive material may provide electrode conductivity, and a suitable electrically conductive material may be used as a conductive material unless it causes a chemical change. Examples of the conductive material may include a carbon material such as natural graphite, artificial graphite, carbon black, acetylene black, ketjen black, a carbon fiber and the like; a metal material of a metal powder or a metal fiber including copper, nickel, aluminum, silver, or the like; a conductive polymer such as a polyphenylene derivative; or a mixture thereof.

The current collector may include Al.

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, or aprotic solvent.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethyl acetate, methyl propionate, ethyl propionate, propyl propionate, v-butyrolactone, decanolide, valerolactone, mevalonolactone, caprolactone, or the like. The ether solvent may include dibutyl ether, tetraglyme, diglyme, dimethoxyethane, 2-methyltetrahydrofuran, 2,5-dimethyltetrahydrofuran, tetrahydrofuran, or the like. The ketone solvent may include cyclohexanone or the like. The alcohol solvent may include ethanol, isopropyl alcohol, or the like. The aprotic solvent may include nitriles such as R—CN (wherein R is a C2 to C20 linear, branched, or cyclic hydrocarbon group, and may include a double bond, an aromatic ring, or an ether bond, and the like); amides such as dimethylformamide; dioxolanes such as 1,3-dioxolane, 1,4-dioxolane, or the like; sulfolanes, or the like.

The organic solvent may be used alone or in a mixture. In an implementation, the organic solvent may be used in a mixture, and the mixture ratio may be controlled in accordance with a desirable battery performance.

In an implementation, the non-aqueous organic solvent may be mixed and used, and a mixed solvent of a cyclic carbonate and a chain carbonate, a mixed solvent of a cyclic carbonate and a propionate solvent, or a mixed solvent of a cyclic carbonate, a chain carbonate, and a propionate solvent may be used. The propionate solvent may include methyl propionate, ethyl propionate, propyl propionate, or a combination thereof.

In an implementation, the cyclic carbonate and the chain carbonate or the cyclic carbonate and the propionate solvent may be mixed, e.g., in a volume ratio of about 1:1 to about 1:9, and thus performance of an electrolyte solution may be improved. In an implementation, the cyclic carbonate, the chain carbonate, and the propionate solvent may be mixed in a volume ratio of, e.g., about 1:1:1 to about 3:3:4. The mixing ratios of the solvents may be appropriately adjusted according to desirable properties.

In an implementation, the organic solvent may further include an aromatic hydrocarbon solvent as well as the carbonate solvent. The carbonate solvent and aromatic hydrocarbon solvent may be mixed together in a volume ratio of about 1:1 to about 30:1.

The aromatic hydrocarbon organic solvent may be an aromatic hydrocarbon compound represented by Chemical Formula 1.

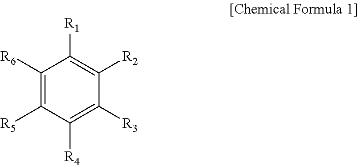

In Chemical Formula 1, R₁ to R₆ may each independently be or include, e.g., hydrogen, a halogen, a C1 to C10 alkyl group, a haloalkyl group, or a combination thereof.

In an implementation, the aromatic hydrocarbon organic solvent may include, e.g., benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

In an implementation, the electrolyte may further include vinylethyl carbonate, vinylene carbonate, or an ethylene carbonate compound represented by Chemical Formula 2 as an additive for improving cycle life.

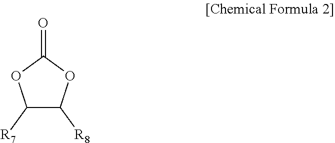

In Chemical Formula 2, R₇ and R₈ may each independently be or include, e.g., hydrogen, a halogen, a cyano group (CN), a nitro group (NO₂), or a C1 to C5 fluoroalkyl group, provided that at least one of R₇ and R₈ is or includes a halogen, a cyano group (CN), a nitro group (NO₂), or a C1 to C5 fluoroalkyl group, and R₇ and R₈ are not simultaneously hydrogen.

In an implementation, the ethylene carbonate compound may include, e.g., difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, or the like. An amount of the additive for improving the cycle-life characteristics may be used within a suitable range.

The lithium salt dissolved in an organic solvent may supply a battery with lithium ions, may basically operate the rechargeable lithium battery, and may help improve transportation of the lithium ions between a positive electrode and a negative electrode. Examples of the lithium salt may include LiPF₆, LiBF₄, LiSbF₆, LiAsF₆, LiN(SO₂C₂F₅)₂, Li(CF₃SO₂)₂N, LiN(SO₃C2F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer of about 1 to about 20, lithium difluoro(bisoxolato) phosphate), LiCl, LiI, LiB(C₂O₄)₂ (lithium bis(oxalato) borate)(LiBOB), or lithium difluoro(oxalato)borate (LiDFOB). A concentration of the lithium salt may range from about 0.1 M to about 2.0 M. Maintaining the concentration of the lithium salt within the above range may help ensure that an electrolyte may have excellent performance and lithium ion mobility due to optimal electrolyte conductivity and viscosity.

A separator may be between the positive electrode and the negative electrode depending on a type of a rechargeable lithium battery. The separator may include polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, or the like.

The FIGURE is an exploded perspective view of a rechargeable lithium battery according to an embodiment. In an implementation, as illustrated in the drawing FIGURE, the rechargeable lithium battery may be a prismatic battery, or may include variously-shaped batteries such as a cylindrical battery, a pouch battery, or the like.

Referring to the FIGURE, a rechargeable lithium battery 100 according to an embodiment may include an electrode assembly 40 manufactured by winding a separator 30 between a positive electrode 10 and a negative electrode 20 and a case 50 housing the electrode assembly 40. An electrolyte may be impregnated in the positive electrode 10, the negative electrode 20 and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

Silicon particles (with an average particle diameter of 8 μm) and Cr₃C₂ were pulverized for 5 hours by ball milling using yttrium-stabilized zirconia balls. The obtained pulverized product had Cr₃C₂ and fine silicon primary particles of which a FWHM(111) was 0.7(°). A weight ratio of the silicon particles and Cr₃C₂ was 2:1.

In ethanol, the pulverized product and stearic acid were mixed at a weight ratio of 8:2, and the mixture was spray-dried at 170° C. This process prepared secondary particles in which silicon primary particles and Cr₃C₂ were agglomerated together. The average particle diameter D50 of the secondary particles was 10 μm.

The prepared secondary particles and petroleum pitch were mixed at a weight ratio of 5:5, and they were heat-treated at 1,000° C. to prepare a negative electrode active material.

The prepared negative electrode active material had secondary particles (in which silicon primary particles and Cr₃C₂ were agglomerated) and a soft carbon coating layer coated on the surface of the secondary particles. The silicon primary particles had a FWHM (111) of 0.7(°), and an amount of the silicon primary particles was 46.7 wt % based on the total weight of the negative electrode active material.

Based on the total weight of the negative electrode active material, an amount of the silicon primary particles was 46.7 wt %, the amount of the soft carbon was 30 wt %, and the amount of Cr₃C₂ was 23.3 wt %. The soft carbon coating layer had a thickness of 1 nm to 1,000 nm. 97.5 wt % of the negative electrode active material, 1.5 wt % of carboxymethyl cellulose, and 1 wt % of a styrene butadiene rubber were mixed in a water solvent to prepare a negative electrode active material layer slurry.

The negative electrode active material layer slurry was coated on a Cu foil current collector, dried, and pressed to form a negative electrode active material layer, thereby preparing a negative electrode.

The negative electrode, a lithium metal counter electrode, and an electrolyte were used to fabricate a half-cell by a general procedure. The electrolyte was a 1M LiPF₆ solution in a mixed solvent of ethylene carbonate and dimethyl carbonate (3:7 volume ratio).

### Example 2

A negative electrode and a half-cell were fabricated by the same procedure as in Example 1, except that a weight ratio of the silicon particles and Cr₃C₂ was changed to 3:2. The FWHM (111) of the silicon primary particles was 0.6(°), and an amount of the silicon primary particles was 42 wt % based on the total weight of the negative electrode active material.

Based on the total weight of the negative electrode active material, an amount of the silicon primary particles was 42 wt %, the amount of the soft carbon was 30 wt %, and the amount of Cr₃C₂ was 28 wt %. The soft carbon coating layer had a thickness of 1 nm to 1,000 nm.

### Example 3

A negative electrode and a half-cell were fabricated by the same procedure as in Example 1, except that a weight ratio of the silicon particles and Cr₃C₂ was changed to a weight ratio of 5:1. The FWHM (111) of the silicon primary particles was 0.6(°), and an amount of the silicon primary particles was 58.3 wt % based on the total weight of the negative electrode active material.

Based on the total weight of the negative electrode active material, an amount of the silicon primary particles was 58.3 wt %, the amount of the soft carbon was 30 wt %, and the amount of Cr₃C₂ was 11.7 wt %. The soft carbon coating layer had a thickness of 1 nm to 1,000 nm.

### Example 4

A negative electrode active material including the silicon primary particles with the FWHM (111) of 0.6(°) at an amount of 46.7 wt %, based on the total weight of the negative electrode active material, and Mo₂C at an amount of 23.3 t %, was prepared by the same procedure as in Example 1, except that Mo₂C was used, instead of Cr₃C₂. Based on the total weight of the negative electrode active material, an amount of the silicon primary particles was 46.7 wt %, the amount of the soft carbon was 30 wt %, and the amount of Cr₃C₂ was 23.3 wt %. The soft carbon coating layer had a thickness of 1 nm to 1,000 nm.

The negative electrode active material was used to fabricate a negative electrode and a half-cell by the same procedure as in Example 1.

### Comparative Example 1

Silicon particles (having an average particle diameter of 8 μm) were pulverized for 5 hours by ball milling using yttrium-stabilized zirconia balls. The obtained pulverized product had silicon primary particles of which a FWHM(111) was 0.5(°).

In ethanol, the pulverized product and stearic acid were mixed at a weight ratio of 8:2, and the mixture was spray-dried at 170° C. This process prepared secondary particles where silicon primary particles were agglomerated. The secondary particles had an average particle diameter D50 of 10 μm.

The prepared secondary particles and petroleum pitch were mixed at a weight ratio of 5:5, and they were heat-treated at 1,000° C. to prepare a negative electrode active material.

The prepared negative electrode active material had secondary particles (in which silicon primary particles were agglomerated) and a soft carbon coating layer coated on the surface of the secondary particles. The soft carbon coating layer had a thickness of 1 nm to 1,000 nm.

Based on the total weight of the negative electrode active material, an amount of the silicon primary particles was 70 wt % and an amount of the soft carbon was 30 wt %.

A negative electrode and a half-cell were fabricated by the same procedure as in Example 1, except that the negative electrode active material was used.

### Comparative Example 2

Silicon particles (having an average particle diameter of 8 μm) was pulverized for 10 hours by ball milling using yttrium-stabilized zirconia balls. The obtained pulverized product had silicon primary particles of which a FWHM(111) was 0.5(°).

In ethanol, the pulverized product and stearic acid were mixed at a weight ratio of 8:2, and the mixture was spray-dried at 170° C. This process prepared secondary particles where silicon primary particles were agglomerated. The secondary particles had an average particle diameter D50 of 10 μm.

The prepared secondary particles and petroleum pitch were mixed at a weight ratio of 5:5, and they were heat-treated at 1,000° C. to prepare a negative electrode active material.

The prepared negative electrode active material had secondary particles (in which silicon primary particles were agglomerated) and a soft carbon coating layer coated on the surface of the secondary particles. The soft carbon coating layer had a thickness of 20 nm to 200 nm.

Based on the total weight of the negative electrode active material, an amount of the silicon primary particles was 70 wt % and the amount of the soft carbon was 30 wt %.

A negative electrode and a half-cell were fabricated by the same procedure as in Example 1, except that the negative electrode active material was used.

### Comparative Example 3

The negative electrode active material prepared by Comparative Example 1 was used as a first negative electrode active material, and Cr₃C₂ was used as a second negative electrode active material to prepare a mixed negative electrode active material at a weight ratio of the first and the second negative electrode active materials of 45:25.

97.5 wt % of the mixed negative electrode active material, 1.5 wt % of carboxymethyl cellulose, and 1 wt % of a styrene butadiene rubber were mixed in a water solvent to prepare a negative electrode active material layer slurry.

The negative electrode active material layer slurry was coated on a Cu foil current collector, dried, and pressed to form a negative electrode active material layer, thereby preparing a negative electrode.

The negative electrode, a lithium metal counter electrode, and an electrolyte were used to fabricate a half-cell by a general procedure. The electrolyte was a 1M LiPF₆ solution in a mixed solvent of ethylene carbonate and dimethyl carbonate (3:7 volume ratio).

### Experimental Example 1) Evaluation of Full Width at Half Maximum

The X-ray diffraction for silicon in the negative electrode active materials according to Examples 1 to 4 and Comparative Examples 1 to 3 was carried out by using a CuKα to measure a full width at a half maximum, FWHM (111) at a (111) plane.

The X-ray diffraction analysis was measured under a condition of a scan speed (°/S) of 0.054, a step size (°/step) of 0.01313, and time per step of 62.475 s in a range of 2θ=10° to 80°. The measured results are shown in Table 1.

### Experimental Example 2) Evaluation of Charge and Discharge Efficiency

The half-cells according to Examples 1 to 4 and Comparative Examples 1 to 3 were charged and discharged at 0.1 C once, and a ratio of the measured discharge capacity relative to the measured charge capacity was calculated. The results are shown in Table 1, as efficiency.

### Experimental Example 3) Evaluation of Cycle-Life Characteristic

The half-cells according to Example 1 to 4 and Comparative Examples 1 to 3 were charged and discharged at 1 C. A ratio of capacity relative to discharge capacity at the 1^{st} cycle was measured. This ratio of capacity, e.g., the number of cycles until the capacity retention was reached to 80%, are shown in Table 1.

TABLE 1

| | | Specific | | Cycle |
|---|---|---|---|---|
| | FWHM | capacity | Efficiency | number |
| | (111, °) | (mAh/g) | (%) | (No.) |
| Example 1 | 0.7 | 1463 | 85 | 545 |
| Example 2 | 0.6 | 1490 | 86 | 515 |
| Example 3 | 0.6 | 1531 | 86 | 490 |
| Example 4 | 0.6 | 1465 | 85 | 430 |
| Comparative | 0.5 | 1650 | 88 | 325 |
| Example 1 | | | | |
| Comparative | 0.7 | 1443 | 85 | 450 |
| Example 2 | | | | |
| Comparative | 0.5 | 1325 | 83 | 150 |
| Example 3 | | | | |

As shown in Table 1, Examples 1 to 4, in which metal carbide was used in the ball milling to include metal carbide in the negative electrode active material and the primary particles of the negative electrode active material had FWHM (111) of greater than 0.5°, exhibited excellent efficiency. The cells of Examples 1 to 4 showed that the number of charge and discharge cycles to reach 80% capacity retention was 430 cycles or more, indicating excellent capacity retention.

Whereas, Comparative Example 1, which did not use Cr₃C₂ in the ball milling, exhibited a FWHM (111) of the primary particles of 0.5°, and the number of charge and discharge cycles to reach 80% capacity retention was 325 cycles, indicating poor capacity retention. Comparative Example 2 in which Cr₃C₂ was not used in the ball milling and the ball milling was performed for 10 hours, exhibited very low specific capacity, and low specific capacity.

Comparative Example 3, in which the silicon secondary particles and Cr₃C₂ were mixed, had a FWHM(111) of 0.5°, indicating low efficiency and extremely low specific capacity, and exhibited that the number of charge and discharge cycles to reach 80% capacity retention was 150 cycles, indicating very poor capacity retention.

One or more embodiments may provide a negative electrode active material exhibiting high strength and excellent dynamic characteristics.

A negative electrode active material according to one or more embodiments may exhibit excellent dynamic performance.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material, comprising:
a core comprising secondary particles in which silicon primary particles and a metal carbide are agglomerated; and
an amorphous carbon layer on a surface of the core,
wherein the primary particles have a full width at half maximum (FWHM, 111) of greater than about 0.5°.

2. The negative electrode active material as claimed in claim 1, wherein the full width at half maximum of the primary particles is greater than about 0.5° and about 2° or less.

3. The negative electrode active material as claimed in claim 1, wherein the metal carbide is comprised in an amount of about 5 wt % to about 30 wt %, based on a total weight of the negative electrode active material.

4. The negative electrode active material as claimed in claim 1, wherein the metal carbide comprises a metal having a strength of about 1,000 kg/mm² to about 2,000 kg/mm².

5. The negative electrode active material as claimed in claim 4, wherein the metal comprises Cr, Mo, Ta, or a combination thereof.

6. The negative electrode active material as claimed in claim 1, wherein the metal carbide comprises Cr₃C₂, Mo₂C, TaC, or a combination thereof.

7. The negative electrode active material as claimed in claim 1, wherein the amorphous carbon layer further comprises a metal carbide.

8. The negative electrode active material as claimed in claim 1, wherein the silicon primary particles are comprised in an amount of about 30 wt % to about 70 wt %, based on a total weight of the negative electrode active material.

9. A method of preparing a negative electrode active material, the method comprising:
pulverizing silicon particles and a metal carbide by using a ceramic ball to prepare a pulverized product;
adding the pulverized product to a solvent to prepare a dispersed liquid;
spay-drying the dispersed liquid to prepare an agglomerated product;
mixing the agglomerated product with an amorphous carbon precursor; and
heat-treating the resulting mixture.

10. The method of preparing a negative electrode active material as claimed in claim 9, wherein a weight ratio of the silicon particles and the metal carbide is about 1:1 to about 10:1.

11. The method of preparing a negative electrode active material as claimed in claim 9, wherein the metal carbide comprises Cr₃C₂, Mo₂C, TaC, or a combination thereof.

12. The method of preparing a negative electrode active material as claimed in claim 9, wherein the ceramic ball comprises a zirconia ball, an yttrium-stabilized zirconia ball, an alumina ball, or a combination thereof.

13. A rechargeable lithium battery, comprising:
a negative electrode comprising the negative electrode active material as claimed in claim 1;
a positive electrode; and
an electrolyte.
